(19) United States
(12) Patent Application Publication
(10) Pub. No.: US 2017/0069003 A1
(43) Pub. Date: Mar. 9, 2017

(54) Systems and Methods for Permitting Merchants to Manage Fraud Prevention Rules

(71) Applicant: MASTERCARD INTERNATIONAL INCORPORATED, Purchase, NY (US)

(72) Inventors: Deborah E. Barta, Wildwood, MO (US); Michael K. Forbis, St. Louis, MO (US); Timothy R. Zyk, St. Louis, MO (US); Michael Wienke, St. Louis, MO (US); Adam Axe, St. Louis, MO (US); Siddique Hameed, Chesterfield, MO (US); Josh Monroe, Wentzville, MO (US); Rahul Deshpande, St. Louis, MO (US)

(21) Appl. No.: 15/083,431

(22) Filed: Mar. 29, 2016

Related U.S. Application Data
(60) Provisional application No. 62/215,730, filed on Sep. 8, 2015.

(51) Int. Cl. G06Q 30/06; G06Q 30/00

(52) U.S. Cl. CPC G06Q 30/0609; G06Q 30/0185

(57) ABSTRACT

Systems and methods for use in permitting merchant to manage fraud prevention rules are disclosed. One exemplary method includes causing at least one settings interface to be displayed to a merchant via a sales platform. The method also includes receiving, by a computing device, via the at least one settings interface, a merchant-specific selection of a prescribed action relating to transactions, at the merchant and receiving, by the computing device, a merchant-specific selection of a fraud prevention rule associated with the prescribed action. The fraud prevention rule defines merchant-specific criteria relating to the transactions. In addition, the method includes appending, by the computing device, the fraud prevention rule to a data structure, in association with the merchant, whereby the prescribed action is effected when a transaction to the merchant violates the criteria defined by the fraud prevention rule.

### CROSS-REFERENCE TO RELATED APPLICATION

This application claims the benefit of, and priority to, U.S. Provisional Application No. 62/215,730 filed on Sep. 8, 2015. The entire disclosure of the above application is incorporated herein by reference.

### FIELD

The present disclosure generally relates to systems and methods for permitting merchants to manage fraud prevention rules for transactions involving the merchants, where the fraud prevention rules are specific to the merchants, and further for inhibiting fraudulent transactions at the merchants by use of the merchant-specific fraud prevention rules.

### BACKGROUND

This section provides background information related to the present disclosure which is not necessarily prior art.

Merchants often offer products (e.g., goods and services, etc.) for sale to consumers. The products may be purchased through a variety of means, including, for example payment accounts. As part of the product purchases, via the payment accounts, by the consumers, data is transferred between different entities to authorize, settle and/or clear the transactions, i.e., transaction data. The transaction data may be used to identify fraudulent transactions and/or compile techniques to combat fraudulent transactions, etc.

### DRAWINGS

The drawings described herein are for illustrative purposes only of selected embodiments and not all possible implementations, and are not intended to limit the scope of the present disclosure.

FIG. 1 is an exemplary system for use in permitting merchants to manage one or more fraud prevention rules for transactions involving the merchants;

FIG. 2 is a block diagram of an exemplary computing device, suitable for use in the system of FIG. 1;

FIG. 3 is a flowchart of an exemplary method for permitting merchants to manage one or more fraud prevention rules, which can be implemented via the system of FIG. 1;

FIGS. 4-6 are exemplary interfaces that may be displayed in connection with the system of FIG. 1 and/or the method of FIG. 3;

FIG. 7 is a flowchart of an exemplary method for inhibiting fraudulent transactions, which can be implemented via the system of FIG. 1;

FIGS. 8-10 are exemplary interfaces that may be displayed in connection with the system of FIG. 1 and/or the method of FIG. 7; and

FIGS. 11 and 12 are exemplary interfaces that may be displayed in connection with the system of FIG. 1 and/or the methods of FIGS. 3 and/or 7.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks (or other entities), for example, in connection with payment device transactions by consumers. The transaction data may be aggregated, culled, divided, and/or analyzed in a number of different ways to gain insight into whether the transactions are consistent with a consumer's general practices, or includes some indicator of fraud. Payment networks, and parts associated therewith, employ multiple anti-fraud techniques, which aim to halt fraudulent transactions during authorization, for example. The systems and methods herein provide for merchants to institute fraud prevention (and protection) rules, to which transactions at the merchants may be subjected. Such rules may include, for example, further review of the transactions, authentication of consumers performing the transactions, and/or decline of the transactions. In particular, a merchant may register to a fraud-control engine, which permits the merchant to impose certain rules (i.e., fraud prevention rules) and prescribe certain actions to be taken when the rules are violated. For example, the merchant may impose rules in which transactions over a certain amount are either declined or subjected to further authentication of the consumer. In this manner, the merchant is able to control particular fraud prevention rules governing transactions to the merchant, whereby the merchant is able to tailor, through the rules, fraud indicators and/or forecasting factors known to the merchant.

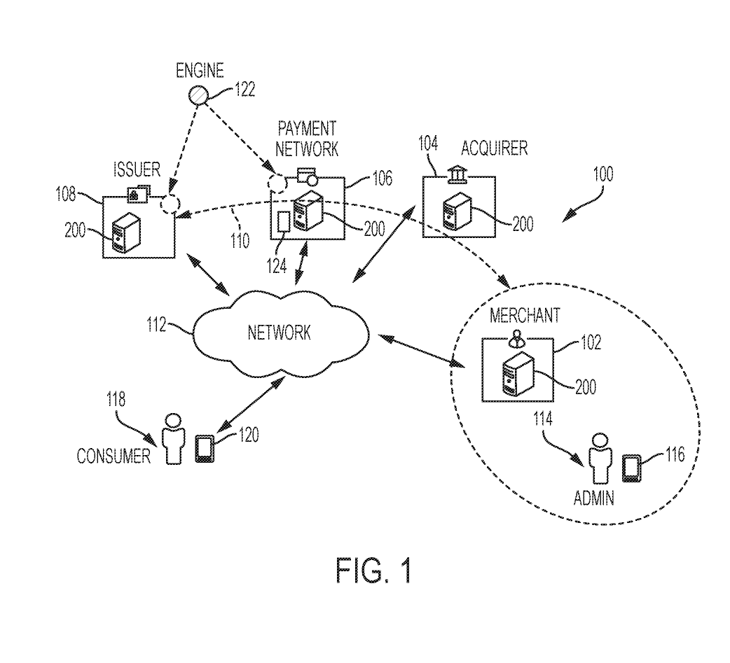

FIG. 1 illustrates an exemplary system 100, in which the one or more aspects of the present disclosure may be implemented. Although parts of the system 100 are presented in one arrangement, other embodiments may include the same or different parts arranged otherwise, depending, for example, on authorization processes for purchase transactions, communication between computing devices, etc.

The illustrated system 100 generally includes a merchant 102, an acquirer 104, a payment network 106, and an issuer 108, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which is accessible as desired to the merchant 102 (and/or an administrator 114 associated with the merchant 102), the acquirer 104, the payment network 106, the issuer 108, and a consumer 118.

As shown in FIG. 1, the merchant 102 is associated with (as indicated by the dotted line) the administrator 114 (or admin), which may include, for example, a manager, an employee, an owner of the merchant 102, or other part acting on behalf of the merchant 102, etc. As used herein, the admin 114 is generally associated with operation of the merchant 102 and/or fraud prevention at the merchant 102, whereby the admin 114 is involved, as described in detail below, in operations associated with the systems and methods described herein. The admin 114 is associated with a communication device 116.

In addition, the system 100 further includes the consumer 118, which is also associated with a communication device 120. In this embodiment, the consumer 118 is a purchaser of one or more products (e.g., goods and/or services, etc.) at the merchant 102, via one or more payment accounts, or other manners of payment, etc. Generally in the system 100, the merchant 102, the acquirer 104, the payment network 106, and the issuer 108 cooperate, in response to the consumer 118 (e.g., a purchase by the consumer 118), to complete a purchase transaction for the product(s) (when a payment account is employed). In the exemplary embodiment, the consumer 118 initiates the transaction by presenting a payment device, such as a credit card, a debit card, a pre-paid card, a payment token, a payment tag, a pass, another device used to provide an account number (e.g., communication device 120, a mobile phone, a tablet, etc.), etc., to the merchant 102.

In the purchase transaction by the consumer 118, for example, the merchant 102 reads the payment device (associated with the consumer's payment account) and communicates an authorization request (including, for example, a primary account number (PAN) for the consumer's payment account and an amount of the purchase, etc.) to the acquirer 104 through the network 112 to determine if the payment account is in good standing and if there is sufficient credit/funds to complete the transaction. The acquirer 104, in turn, communicates with the issuer 108, through the payment network 106, via the network 112, for authorization for the transaction. The path of the authorization request is indicated by the dotted line in FIG. 1, which is referenced 110 and described in more detail below. If the issuer 108 accepts the transaction, an authorization reply is provided back to the merchant 102, authorizing the transaction, and the merchant 102 completes the transaction. The credit line or funds associated with the consumer's payment account, depending on the type of payment account, is then decreased by the amount of the purchase, and the charge is posted to the payment account. The transaction is later cleared and settled by and between the merchant 102 and the acquirer 104 (in accordance with a settlement arrangement, etc.), and by and between the acquirer 104 and the issuer 108 (in accordance with another settlement arrangement, etc.). Certain accounts, such as debit payment accounts, when used in such a transaction, may further include the use of a personal identification number (PIN) authorization and more rapid posting of the charge to the account associated with the card, etc. Conversely, if the issuer 108 declines the transaction, an authorization reply is provided back to the merchant 102, declining the transaction, and the merchant 102 can stop the transaction.

Transaction data is generated, collected, and stored as part of the above interactions among the merchant 102, the acquirer 104, the payment network 106, the issuer 108, and the consumer 118. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104, and/or the issuer 108 may store the transaction data, or part thereof, in a data structure. Or transaction data may be transmitted between entities of system 100, as used or needed.

Transaction data may include, for example, payment account numbers, amounts of transactions, merchant IDs, merchant category codes, dates/times of transactions, products purchased and related descriptions or identifiers, products refunded, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108. Further, transaction data, unrelated to a particular payment account, may be collected by a variety of techniques, and similarly stored within the system 100.

In various exemplary embodiments, consumers involved in the different transactions herein are prompted to agree to legal terms associated with their payment accounts, for example, during enrollment in their accounts, etc. In so doing, the consumers may voluntarily agree, for example, to allow merchants, issuers of the payment accounts, payment networks, etc., to use data collected during enrollment and/or collected in connection with processing the transactions, subsequently for one or more of the different purposes described herein.

In addition, while only one merchant 102, one acquirer 104, one payment network 106, one issuer 108, one admin 114, and one consumer 118 are illustrated in FIG. 1 (for ease of reference), it should be appreciated that a variety of other embodiments may include multiple ones of these entities in various combinations and, in some of these embodiments, even hundreds or thousands of certain ones of these entities.

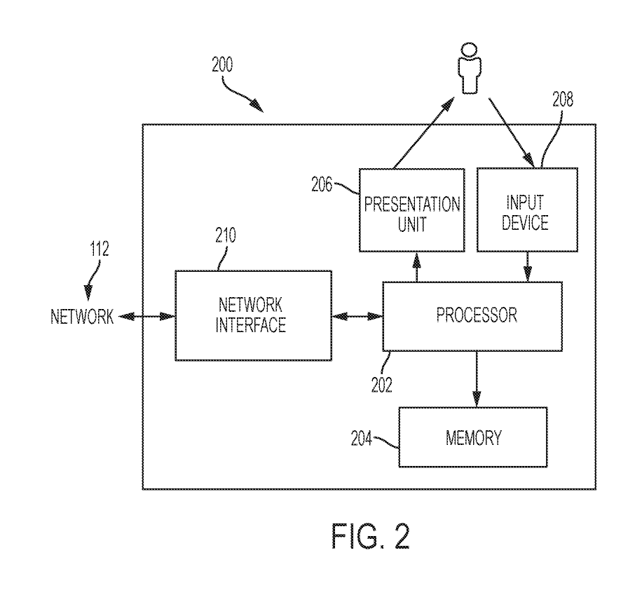

FIG. 2 illustrates an exemplary computing device 200 that can be used in the system 100. The computing device 200 may include, for example, one or more servers, workstations, personal computers, laptops, tablets, smartphones, point of sale (POS) terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in, computing device 200, coupled to (and in communication with) the network 112. In addition, the admin 114 and the consumer 118 also are associated with the communication devices 116 and 120, both of which are consistent with computing device 200. The communication devices 116 and 120 often include portable communication devices, such as, tablets or smartphones, etc.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may include one or more data structures, and may further be configured to store, without limitation, transaction data, fraud prevention rules, fraud scores, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

In the exemplary embodiment, the computing device 200 includes a presentation unit 206 (or an output device or a display device) that is coupled to (and in communication with) the processor 202 (however, it should be appreciated that the computing device 200 could include output devices other than the presentation unit 206, etc.). The presentation unit 206 outputs information (e.g., notifications, etc.), either visually or audibly to a user, for example, the consumer 118 in the system 100, the admin 114 in the system 100, etc. It should be further appreciated that various interfaces (e.g., application interfaces, webpages, etc.) may be displayed at computing device 200, and in particular at presentation unit 206, to display information, such as, for example, settings, notifications, or other data, in the form of interfaces, or otherwise, as described herein, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 also includes an input device 208 that receives inputs from the user of the computing device 200 (i.e., user inputs) such as, for example, selections of settings, rules, etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202.

Referring again to FIG. 1, the system 100 includes a fraud-control engine 122, which is specifically configured, by executable instructions, to perform one or more of the operations herein. As shown in FIG. 1, the engine 122 is illustrated apart from the payment network 106 and the issuer 108 (i.e., as a third party), but, as indicated by the dotted lines, may be incorporated with either. In other embodiments, however, it should be appreciated that the engine 122 may be incorporated with other parts of the system 100 (e.g., the acquirer 104, etc.).

Also in the system 100, the merchant 102 offers products (e.g., goods and services) for sale through a brick and mortar sales platform and also through a virtual store front (broadly, a sales platform), which may be offered and/or hosted by the merchant 102, or by another part of the system 100. In this example, the payment network 106 offers a sales platform 124, as a service to merchant 102, particularly where the merchant 102 is smaller in scale and/or of insufficient size to generate and/or manage a merchant-specific sales platform. The sales platform 124 may be active in/during any part of processing the purchase transaction to the payment account, as described above, or even before and/or after the authorization request is transmitted to the acquirer 104, or even further as part of the clearing and/or settlement aspects of the transaction, etc. Moreover, the sales platform 124 is provided in the form of an internet-based application, through which the merchant 102 is able to offer products for sale. In other embodiments, the sales platform 124 may include a website or internet-based application, hosted, in whole or in part, by the merchant 102, or by a third party associated with the merchant 102.

As illustrated in FIG. 1, the engine 122 is associated with the sales platform 124 via the payment network 106, and may further be incorporated (in whole or in part) therein. Generally, the engine 122 provides enhanced services to the certain processes of the sales platform 124, but should not be understood to be limited to the sales platform 124 or any particular sales platform (virtual or otherwise).

For purpose of illustration, the engine 122 is described herein as at least partially incorporated with the sales platform 124. A dashboard interface (e.g., in the form of a website or internet-based application, etc.) is accessible to the sales platform 124, through which the merchant 102 is permitted to append new products, remove old products, offer discounts, set sales conditions, etc. As part of the service, in this exemplary embodiment, the engine 122 interacts with the merchant 102 (and more specifically, the admin 114) through the interface(s) associated with the sales platform 124. Uniquely herein, the merchant 102 is then also permitted to provide fraud prevention rules that are specific to the merchant 102, and that are employed by and/or through the sales platform 124 (in this exemplary embodiment), in processing purchase transactions at the merchant 102 for product(s).

Specifically, the engine 122 is configured to receive one or multiple inputs from the admin 114 associated with the merchant 102, via one or more interfaces presented at the communication device 116 (e.g., via a website or internet-based application, etc.), which define fraud prevention rules to be implemented at the merchant 102 both by prescribed actions and by criteria for coordinating the prescribed actions. The criteria may relate to, for example, an amount per transaction, frequency of transactions to the merchant and/or to a particular payment account, location of transactions/shipments, transaction security, fraud scores, etc. In addition, the engine 122 is configured to, in turn, append the fraud prevention rules (and any later modifications and/or revisions to the rules received from the admin 114) to a rules data structure (e.g., a fraud protection rule set, etc.) (not shown) specific to the merchant 102 and/or in association with the merchant 102. Then, when transactions to the merchant 102 are attempted, the fraud prevention rules are employed by the platform 124 (and/or the engine 122), or by other parts of the system 100, for example, to determine whether the rules (and/or the criteria defined thereby) are violated, and to coordinate the prescribed actions when violated. The prescribed actions may include, for example, notifying the merchant 102 (or the admin 114) of a need for the merchant's review of the transaction, requesting the consumer 118 (often through the virtual sales platform 124, or other application associated with and/or known to engine 122) to perform certain authentications, declining the transaction, etc.

Thus, the fraud prevention rules provided to the engine 122 by the merchant 102 are generally specific to the merchant 102. The criteria specified by the merchant 102 for selected rules may be data/business specific to the merchant 102, and may be based on recent trends and/or factors associated with the merchant 102 (or not). In addition, the criteria (and/or the selection of rules) may be updated by the merchant 102 as warranted or as the merchant's business changes. As such, the specific fraud prevention rules provided by the merchant 102 may improve security for the particular merchant 102 (based on the merchant's business, products sold, consumers serviced, etc.), over merchant-generic rules intended to apply to a wide range of different merchants.

In this exemplary embodiment, the engine 122 is configured to further provide one or more reporting notifications (e.g., via a website or internet-based application, etc.) to the merchant 102 or the admin 114, indicative of the use of the fraud prevention rules and the potential actions taken in view of such rules. Through such notifications, the merchant 102 is permitted to access the utility and/or efficacy of the rules, and may also be permitted to make any needed potential modifications to the rules and/or associated criteria.

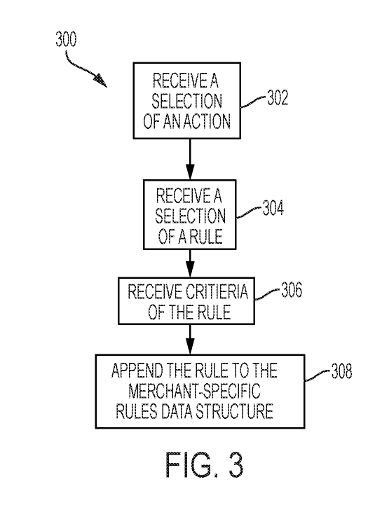

FIG. 3 illustrates an exemplary method 300 for permitting the merchant 102, for example, to manage one or more fraud prevention rules. The exemplary method 300 is described as implemented in the engine 122, in conjunction with the admin 114, which is associated with the merchant 102 and the communication device 116, as well as with reference to the consumer 118 and the associated communication device 120, etc. However, the method 300 is not limited to the system 100. Further, for purposes of illustration, the exemplary method 300 is described herein with reference to the computing device 200, but should not be considered limited thereto Likewise, the systems and the computing devices herein should not be understood to be limited to the exemplary method 300.

Initially in the method 300, in connection with making use of the fraud prevention aspects herein, the merchant 102 is registered to a sales platform (e.g., sales platform 124, etc.), and accesses an associated internet-based application, through which the merchant 102 (or admin 114) is permitted to alter various aspects of the products and/or conditions of sales through the platform, which in turn causes at least one settings interfaces (i.e., one or more settings interfaces, etc.) to be displayed to the admin 114, at communication device 116.

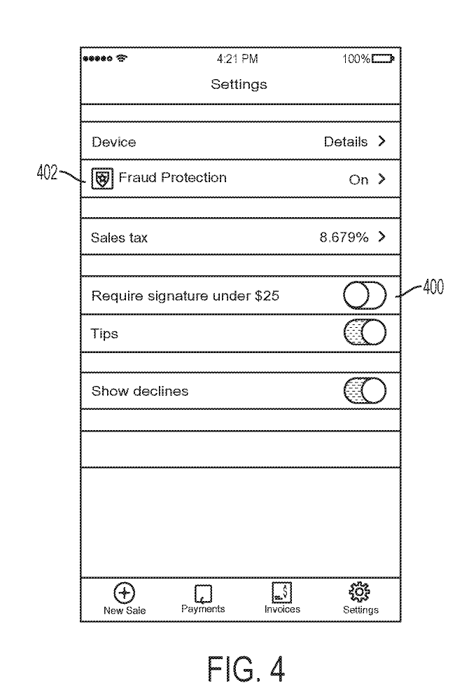

In connection therewith, FIG. 4 illustrates an exemplary settings interface 400, which may be displayed to the admin 112, and through which the merchant 102 (or the admin 114) is permitted to change sales tax, require signatures, and/or permit tipping, etc. In addition, the interface 400 includes a setting section 402 for a “Fraud Protection” service of the sales platform 124, which is associated with the engine 122. Again, it should be appreciated that while the settings interface 400 (and other interfaces below) is/are described with reference to an internet-based application or a website, other manners of providing interfaces, often internet-based interfaces, to the merchant 102 may be employed in other examples. What's more, while referred to as different interfaces, it should be appreciated that the various interfaces described herein may be part of the same interface (e.g., as separate pages, portions, etc.).

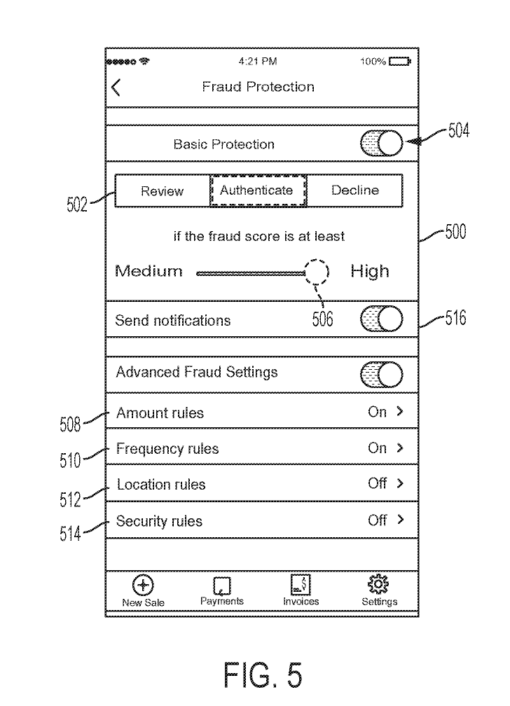

Upon selection of the fraud protection setting section 402, the engine 122, in combination with, or as part of, the platform 124, causes a fraud settings interface 500, as shown in FIG. 5, to be displayed to the admin 114 at communication device 116. As shown, in this embodiment, the engine 122 provides different available prescribed actions 502 (i.e., review, authenticate, and decline) and multiple associated criteria (in connection with rules 504, 508-514) for selection to the admin 114 (to be implemented in response to purchase transactions at the merchant 102). Specifically, a review action may cause the underlying transaction to be held, until the merchant 102 (or the admin 114) is able to review and permit the transaction to proceed. By such an action, a message including various details of the transaction may be transmitted to the merchant 102, and particularly to the admin 114, requesting/requiring the merchant 102 to make a decision on whether or not to permit the transaction to proceed. An authenticate action may cause the sales platform 124 (or other communication medium with the consumer 118) to facilitate an authentication process with the consumer 118, prior to permitting the underlying transaction to proceed. Such authentication process may include authentication by a biometric (e.g., fingerprint, facial recognition, etc.) of the consumer 118, or otherwise (e.g., PIN, security question, etc.) etc. A decline action may simply include the sales platform 124, or another part involved in the underlying transaction, declining the transaction.

In response to the interface 500, the admin 114 selects a prescribed action from the options at 502. In turn, and as shown in the method 300 of FIG. 3, the engine 122 receives the selection of the prescribed action, at 302. The admin 114 then selects a fraud prevention rule from the interface 500, to implement in connection with the selected action, and the engine 122 receives the selection of the fraud prevention rule, at 304. The selection may indicate one or more of a variety of rules, both generic and specific, including, for example, basic fraud prevention rules 504 (i.e., automatic rules), amount-based rules 508, frequency-based rules 510, location-based rules 512, and security-based rules 514. Selecting includes, for example, selecting from a number of options or further, in some embodiments, entering or otherwise inputting of a particular fraud prevention rule (i.e., not limited to choosing among predefined ruled, actions, or criteria). The admin 114 then provides the criteria for the particular rule(s) selected (if necessary) (e.g., a dollar amount, a transaction count, a region, etc.). In turn, as shown in FIG. 3, the engine 122 receives the criteria, at 306.

With reference to the exemplary rules 504, 508-514 in the interface 500 of FIG. 5, the “Basic Protection” rule 504 may be selected, with the criteria being set to either “Medium” or “High” by sliding a button 506. This rule 504 permits the sales platform 124, or a third party associated therewith (or other part of system 100), to score the overall transaction on a low-medium-high scale for the transaction, often taking into account numerous conventional indicators of fraudulent transactions (e.g., various different fraud scores, etc.). As shown, the prescribed action that is selected in the illustrated interface 500, from the options at 502, is authenticate. As such, when the “Basic Protection” rule 504 is also selected by the merchant 102, and when the fraud score generated for the underlying purchase transaction is consistent with the criteria setting provided by the merchant 102 in the interface 500 (i.e., is “High”), the sales platform 124 (or other form of communication with the consumer 118) facilitates an authentication process with the consumer 118.

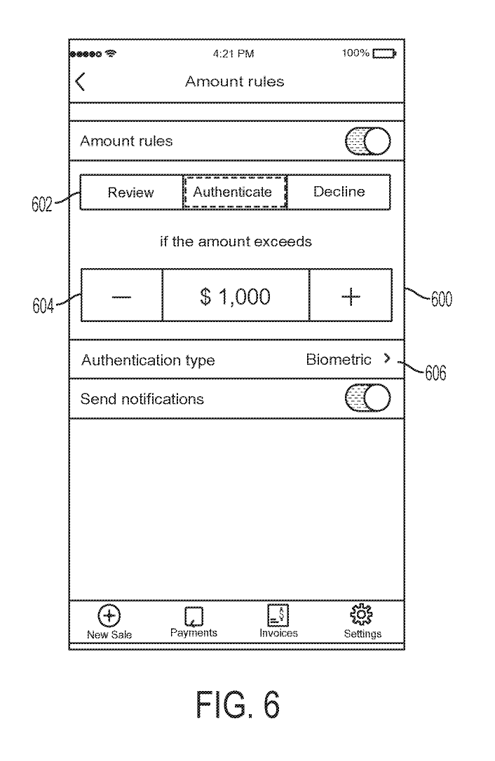

In addition, when the admin 114 instead (or additionally) selects the amount rules 508 at the interface 500, another interface is displayed to the admin 114 at communication device 116. Specifically, as shown in FIG. 6, for example, an amount rules interface 600 is displayed that permits the merchant 102 to modify the prescribed action for the amount rules 508 (as previously selected at the interface 500), at the options at 602, and then to enter (or select) an amount criteria (at box 604), whereby a transaction that exceeds that amount will implement the prescribed action (i.e., the authenticate action in the illustrated interface 600). Thus, in this example, the merchant 102 selects the prescribed action of authenticating the consumer 118, when a transaction by the consumer 118 at the merchant 102 exceeds $1,000. Further, the interface 600 allows the admin 114 to specify a type of authentication to be performed when the amount rules 508 are implicated. For example, in the interface 600, the authentication technique is selected as being biometric, at 606, whereby a biometric associated with the consumer 118 needs to be verified prior to the transaction being permitted to proceed.

When the admin 114 instead (or additionally) selects the frequency rules 510 at the interface 500, the admin 114, via another interface (not shown), for example, is able to enter (or select) criteria relating to a frequency of transactions accepted from a single payment account, a single consumer, etc. by the merchant 102, before the rule is implicated. For example, the merchant 102 may seek to limit a payment account to five transactions in a day, while another merchant may seek to limit a payment account to one transaction per day. It should be appreciated that the number of transactions and/or the interval in which those transaction are to be attempted (or completed) may vary based on the type of merchant, the types of products provided by the merchant 102, or other factors, potentially related to the use of certain products and/or the frequency of product purchase, etc.

When the admin 114 instead (or additionally) selects the location rules 512 at the interface 500, the admin 114, via another interface (not shown), for example, may enter (or select) criteria relating to a match between a billing address for a payment account and a shipping address, with a prescribed action then taking effect when, for example, a shipping address for a product purchased at the merchant 102 does not match the billing address for the payment account used in the transaction, etc. Other location-based rules may include criteria relating to distances between a shipping address and a billing address (for the payment account), distances between a merchant address and a shipping address, no-sale regions (e.g., decline transactions with shipping address in Country X, etc.), merchant and shipping addresses being in different regions, etc.

Finally, when the admin 114 instead (or additionally) selects the security rules 514 at the interface 500, the admin 114 may, via another interface (not shown), for example, enter (or select) criteria relating to a type of payment account used in the underlying transaction at the merchant 102, relating to use of enhanced security protocols such as, for example, 3D-Secure protocol, etc. (e.g., when a payment account is enabled for such security), or relating to other criteria potentially indicative of security associated with the transactions, etc.

It should be appreciated that the admin 114 (or the merchant 102) may create numerous different fraud prevention rules via engine 122 (e.g., through settings interface 400, etc.), which may serve to protect the merchant 102 from instances of fraud. Further, the rules may be different than the exemplary rules provided herein, and/or based on different criteria, etc. Further still, it should be appreciated that multiple rules (even multiple of the same type) may be compiled by the merchant 102 (or admin 114) and employed within the system 100. In some embodiments, multiple rules may be created by the merchant 102 and applicable to a purchase transaction at the merchant 102. In these embodiments, the purchase transaction may satisfy some of the rules, but may violate others.

With continued reference to the interface 500 of FIG. 5, the admin 114 is also provided an option to send notifications, at 516, to the merchant 102 (and/or the admin 114), the consumer 118, and/or others associated with an underlying transaction implicating one of the selected rules. The notifications may be specific to the relevant rule that is implicated by a transaction, or they may be specific to the person/entity receiving the notifications. Such notifications will be described more hereinafter.

Referring again to the method 300 of FIG. 3, once the prescribed action, rule and criteria (if necessary) are received from the merchant 102 (and/or the admin 114), in whatever order, the engine 122 appends the rule to the rules data structure specific to the merchant 102, at 308. The fraud prevention rules, as stored in the rules data structure, are then used, by the engine 122, or other part associated with the sales platform 124 and/or the merchant 102 (or otherwise), for evaluating transactions at the merchant 102 for potential fraud. As indicated, the rules appended to the rules data structure for the merchant 102 are specific to the merchant 102. In other words, a rule appended to the rules data structure for the merchant 102 is not used, by the engine 122, for a different merchant.

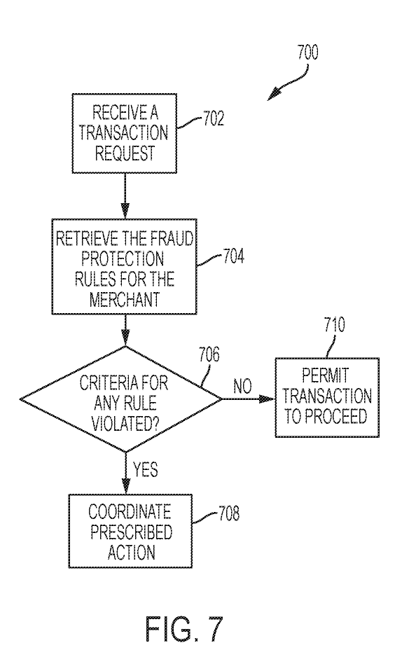

FIG. 7 illustrates an exemplary method 700 for inhibiting fraudulent transactions based on merchant-specific fraud prevention rules. The exemplary method 700 is described as implemented in the engine 122 (via the sales platform 124 provided by the payment network 106 to the merchant 102), and further with reference to the rules compiled in the amount rules interface 600 of FIG. 6 relating to the merchant 102, for example, and a transaction by the consumer 118 at the merchant 102, etc. However, and as previously stated, the methods herein are not limited to the system 100 and/or the device 200 Likewise, the systems and the computing devices herein should not be understood to be limited to the exemplary method 700.

In one example, application of the method 700 is described in connection with a transaction for two speakers. In particular in this example, the consumer 118 submits a transaction to the merchant 102 for two speakers that are $500 each, whereby the total amount of the transaction (with tax) is $1,005.00.

As shown in FIG. 7, upon submission by the consumer 118 of the transaction to merchant 102 (via the sales platform 124, either directly at the merchant 102 or via the network 112), the engine 122 (as part of the sales platform 124) receives the transaction request, at 702. In turn, at 704, the engine 122 retrieves the fraud prevention rules, from the rules data structure, specific to the merchant 102 (e.g., as appended at 308 in method 300, etc.), and determines if a criteria of the rules has been violated, at 706.

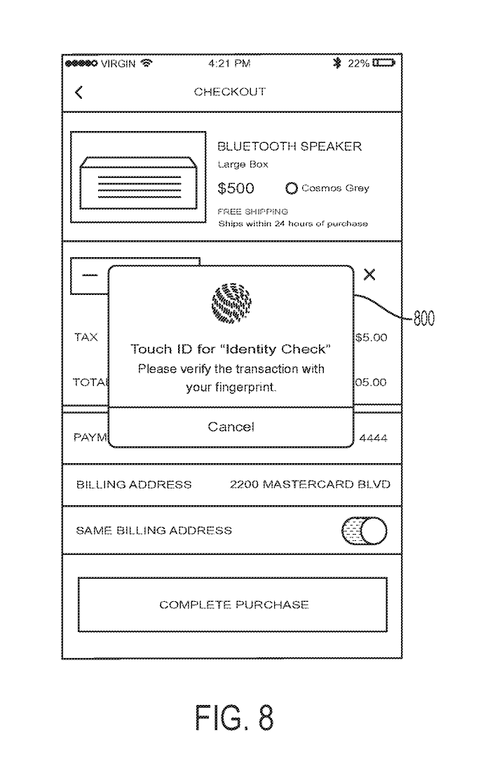

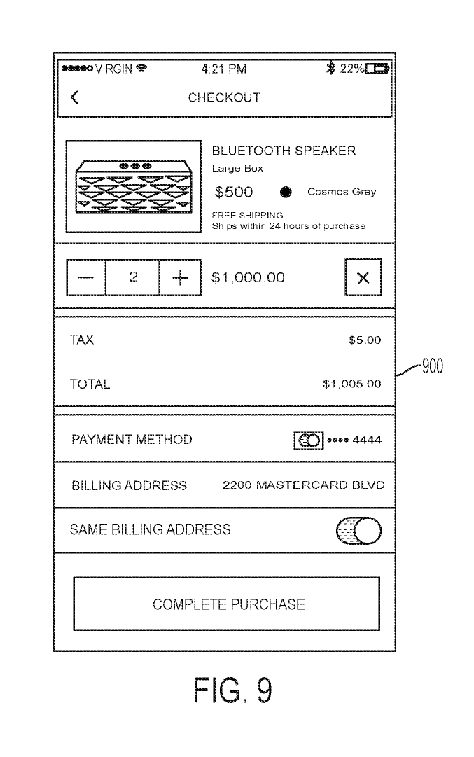

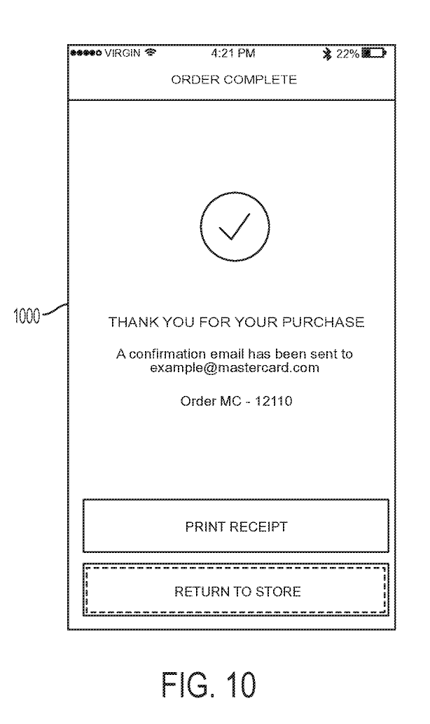

With reference to the rules appended to the data structure, via interface 600 of FIG. 6, the amount of the transaction by consumer 118 violates (or exceeds) the $1,000 limit/criteria on transactions. As such, at 706 in the method 700, the engine 122 determines the criteria to be violated and coordinates, at 708, the prescribed action associated with the rule. As shown in FIG. 6, the prescribed action at 606 is to authenticate the consumer 118 via a biometric. As such, as shown in FIG. 8, an authentication interface 800 is displayed to the consumer 118 in connection with the transaction (e.g., caused by the engine 122, etc.), at the consumer's communication device 120, through which the consumer 118 is prompted to provide/apply a fingerprint (broadly, a biometric) so that the consumer 118 can be authenticated. Upon receipt of the biometric (and upon verification thereof, by the engine 122, for example, as compared to a reference biometric, or by another entity), the sales platform 124, as shown in exemplary checkout interface 900 of FIG. 9, permits the transaction to proceed. And, a confirmation interface 1000, as shown in FIG. 10, is then displayed by the sales platform 124 at communication device 120. The engine 122, at that time, or prior (or thereafter), causes an authorization request for the transaction to be submitted to the acquirer 104 (associated with the merchant 102). Conversely, if at 706, the criteria for the amount rules are not violated, the engine 122 permits the transaction to proceed, at 710.

In another example, application of the method 700 is described in connection with a transaction by the consumer 118 to the merchant 102, and for which a fraud prevention rule is implicated that relates to a fraud score for the transaction. In particular in this example, upon receiving a transaction request from the consumer 118, at 702 (at the sales platform 124), the engine 122 retrieves the particular fraud prevention rule, at 704. In addition, the engine 122 calls a fraud provider (not shown) to determine a fraud score for the transaction, by one or more fraud scoring algorithms. In doing so, in this example, the engine 122 provides a variety of details about the transaction, which the fraud provider utilizes (in whole or in part) to determine the fraud score, often based on conventional fraud protection techniques. When the fraud score is returned to the engine 122, the engine 122 then determines, at 706, if a fraud score criteria defined by the merchant's fraud prevention rule is violated, or not. If violated, as above, the engine 122 effects the appropriate prescribed action, at 708, and if not, permits the transaction to proceed, at 710.

In the above examples, the engine 122 (as part of sales platform 124) generally reviews the transactions when received at the sales platform 124, based on the fraud prevention rules for the merchant 102, prior to or in connection with the merchant 102 submitting an authorization request for the transaction to the acquirer 104, as described above. In this manner, permitting the transaction to proceed, by the engine 122, may include permitting the merchant 102 (e.g., via the sales platform 124, etc.) to transmit the authorization request to the acquirer 104 associated with the merchant 102, or may include permitting the authorization request to be transmitted to the payment network 106 or the issuer 108 (depending on where the engine 122 intercepts or receives the authorization request). In one or more other embodiments, the method 700 may be performed during or after the authentication request is transmitted to the acquirer 104 (e.g., at the payment network 106, at the issuer 108, etc.), where the engine 122 may intercept or otherwise receive the authorization request and determine if one or more fraud prevention rules for the merchant 102 are applicable to the transaction. Alternatively, the method 700 may be performed during or after an authentication reply is transmitted by the issuer 108 (e.g., the engine 122 may intercept or otherwise receive the authentication reply, for example, at the issuer 108, at the payment network 106, at another location, etc.), or even during the clearing and/or settlement process, etc.

At this point, it should be appreciated that the engine 122 may be separated into a rules generation aspect and a rules enforcement aspect, in which the engine 122 is segregated between two or more computing devices. The particular setup and/or segregation of the engine 122 (if any) may impact the manner in which a transaction is inhibited and/or permitted to proceed as described herein.

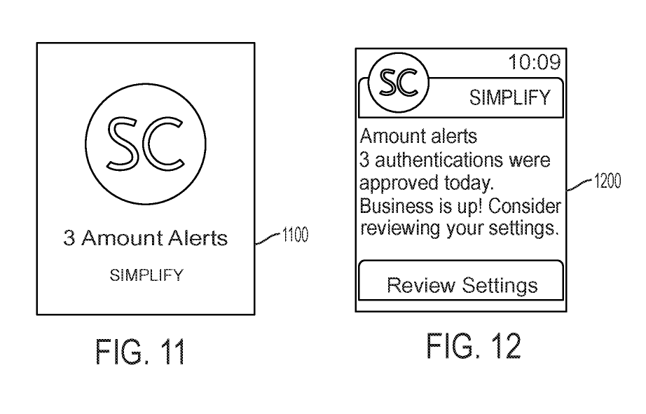

As the fraud prevention rules are employed in system 100 and/or the method 700, prescribed actions (e.g., review, authenticate, decline, etc.) are expected to occur. The engine 122, in addition to the above, further provides notifications to the merchant 102, indicating the impact of the fraud prevention rules. FIGS. 11 and 12 illustrate exemplary notification interfaces 1100 and 1200 sent, by the engine 122, to the merchant 102 (and the admin 114) to inform of the rules violations. In the interface 1100 of FIG. 11, for example, the merchant 102 is informed of the number of amount violations in a prior twenty-four hour period.

In the interface 1200 of FIG. 12, for example, the same notification is provided, but a suggestion to review the amount rules is also provided (with a direct link to either the settings interface 400 of FIG. 4 or the fraud settings interface 500 of FIG. 5). It should be appreciated that any different number of notifications in any form may be passed from the engine 122 to the merchant 102 to inform and/or advise the merchant 102 relative to the fraud prevention rules described herein.

As can now be appreciated, systems and methods herein provide a merchant-specific option, which may be employed in combination with (or as an alternative to) conventional fraud protection techniques, in order to enhance protection of merchants against fraudulent transactions. The rules provided herein permit the merchants to recognize trends and/or factors, which may be specific to the merchants, and implement rules that are also specific to the merchants. As such, the construction of more generic rules usable for a broader array of merchants (which may be more easily implemented at acquirers, payment networks, or issuers, for example) is avoided. Fraud prevention rules are thus generally specific to the merchants, and managed by the merchants, to provide improved protections over merchant-generic rules.

In addition, while the engine 122 is described herein with reference to the sales platform 124, it should be appreciated that the engine 122, as described herein, may be employed elsewhere in the system 100, in both shown and not shown parts. Specifically, the engine 122 (or parts thereof) may be employed in the acquirer 104 (or multiple acquirers), etc. Further, the engine 122 (or parts thereof) may be employed in independent sales organizations (ISOs), payment gateways, payment facilitators, etc. (whether understood to be incorporated into a part shown in FIG. 1, or not). In at least one example, the engine 122 (or parts thereof) is implemented to provides desired flexibility in permitting merchants (or others) to efficiently generate rule sets (i.e., as stored in the rules data structure, etc.), and manage such rule sets over time, with regular or irregular notifications of the result of the rule sets.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) causing at least one settings interface to be displayed to a merchant via a sales platform; (b) receiving, via the at least one settings interface, a merchant-specific selection of a prescribed action relating to purchase transactions at the merchant; (c) receiving a merchant-specific selection of a fraud prevention rule associated with the prescribed action, the fraud prevention rule defining at least one merchant-specific criteria relating to the purchase transactions at the merchant; (d) appending the fraud prevention rule to a fraud protection rule set associated with the merchant, whereby when a purchase transaction to the merchant violates the at least one criteria defined by the fraud prevention rule, the prescribed action is effected; (e) receiving a transaction request for a transaction by a consumer to a merchant; (f) retrieving fraud prevention rules for the merchant, the fraud prevention rules each including a fraud criteria and a prescribed action, the fraud prevention rules defined by the merchant and being specific to the merchant; (g) determining whether any of the fraud criteria, for any of the fraud prevention rules for the merchant, are violated by the transaction; and (h) coordinating, by the computing device, the prescribed action associated with one of the fraud prevention rules, when the fraud criteria of the one fraud prevention rule is violated by the transaction.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in managing fraud prevention rules, the method comprising:
causing at least one settings interface to be displayed to a merchant via a sales platform;
receiving, by a computing device, via the at least one settings interface, a merchant-specific selection of a prescribed action relating to purchase transactions at the merchant;
receiving, by the computing device, a merchant-specific selection of a fraud prevention rule associated with the prescribed action, the fraud prevention rule defining at least one criteria specific to the merchant and relating to the purchase transactions at the merchant; and
appending, by the computing device, the fraud prevention rule to a fraud protection rule set associated with the merchant, whereby when a purchase transaction to the merchant violates the at least one criteria defined by the fraud prevention rule, the prescribed action is effected.

2. The method of claim 1, further comprising receiving, by the computing device, via the at least one settings interface, the at least one criteria for the fraud prevention rule.

3. The method of claim 2, wherein the at least one criteria is associated with at least one of an amount of a purchase transaction, a frequency of purchase transactions made to a payment account, and a location of a purchase transaction.

4. The method of claim 2, wherein the at least one criteria is associated with a fraud score.

5. The method of claim 1, wherein the prescribed action includes declining a purchase transaction.

6. The method of claim 1, wherein the prescribed action includes an authentication of a consumer making a purchase transaction to the merchant, prior to permitting the transaction to proceed.

7. The method of claim 1, further comprising:
receiving, by the computing device, via the at least one settings interface, a merchant-specific selection of a second prescribed action relating to the purchase transactions at the merchant;
receiving, by the computing device, via the at least one settings interface, a merchant-specific selection of a second fraud prevention rule associated with the second prescribed action, via the sales platform, the second rule defining at least one second criteria specific to the merchant; and
appending, by the computing device, the second rule to the fraud protection rule set associated with the merchant, whereby the second prescribed action is effected when a purchase transaction to the merchant violates the second criteria.

8. A computer-implemented method for use in inhibiting fraudulent transactions, the method comprising:
receiving a transaction request for a transaction by a consumer to a merchant;
retrieving, by a computing device, fraud prevention rules for the merchant, the fraud prevention rules each including a fraud criteria and a prescribed action, the fraud prevention rules defined by the merchant and being specific to the merchant;
determining, by the computing device, whether any of the fraud criteria, for any of the fraud prevention rules for the merchant, are violated by the transaction; and
coordinating, by the computing device, the prescribed action associated with one of the fraud prevention rules, when the fraud criteria of the one fraud prevention rule is violated by the transaction.

9. The computer-implemented method of claim 8, further comprising causing an authorization request for the transaction to be transmitted when the fraud criteria of the one fraud prevention rule is not violated.

10. The computer-implemented method of claim 9, wherein the prescribed action associated with the one fraud prevention rule includes a decline of the transaction; and
wherein coordinating the prescribed action includes declining the transaction, prior to transmitting the authentication request for the transaction.

11. The computer-implemented method of claim 9, wherein determining whether any of the fraud criteria are violated includes determining whether any of the fraud criteria are violated prior to transmitting the authorization request for the transaction.

12. The computer-implemented method of claim 8, wherein the prescribed action includes a review of the transaction; and
wherein coordinating the prescribed action includes inhibiting the transaction from proceeding, until a verification for the transaction is received.

13. The computer-implemented method of claim 8, wherein the prescribed action includes an authentication; and
wherein coordinating the prescribed action includes:
causing an authentication interface to be displayed at a communication device associated with the consumer, whereby the consumer is permitted to authenticate himself/herself; and
inhibiting the transaction from proceeding until the authentication is completed by the consumer.

14. The computer-implemented method of claim 8, wherein determining whether any of the criteria are violated includes requesting a fraud score for the transaction from a fraud provider and comparing the fraud score to the fraud criteria for the merchant.

15. A non-transitory computer readable storage media including instructions for managing fraud prevention rules and inhibiting fraudulent transactions, which when executed by at least one processor, cause the at least one processor to:
receive, from a merchant, a selection of a rule relating to fraud prevention in connection with transactions involving the merchant, the selected rule including a fraud criteria and a prescribed action to be taken when the fraud criteria is violated;
store the selected rule in a data structure, in association with the merchant;
when a transaction to the merchant violates the fraud criteria of the selected rule, cause the prescribed action to be taken; and
when the transaction to the merchant does not violate the fraud criteria, cause processing of the transaction to one or more of an acquirer associated with the merchant, a payment network, and an issuer associated with a payment account involved in the transaction.

16. The non-transitory computer readable storage media of claim 15, wherein the instructions, when executed by the at least one processor, further cause the at least one processor to, after storing the selected rule in the data structure, identify the selected rule in response to the transaction and retrieve the selected rule from the data structure.

17. The non-transitory computer readable storage media of claim 15, wherein the instructions, when executed by the at least one processor, further cause the at least one processor to register the merchant to a sales platform through which the merchant is able to specify settings relating to transactions at the merchant, including selection of the rule relating to fraud prevention in connection with the transactions.

18. The non-transitory computer readable storage media of claim 16, wherein the sales platform includes at least one interface; and
wherein the instructions, when executed by the at least one processor, cause the at least one processor, in order to register the merchant, to cause the at least one interface to be displayed to the merchant, through which the merchant is permitted to also select the rule relating to fraud prevention in connection with the transactions to the merchant.

19. The non-transitory computer readable storage media of claim 15, wherein the instructions, when executed by the at least one processor, in connection with causing processing of the transaction to one or more of an acquirer associated with the merchant, a payment network, and an issuer associated with a payment account involved in the transaction, when the transaction to the merchant does not violate the fraud criteria, cause the at least one processor to transmit an authorization request for the transaction to one or more of the acquirer, the payment network, and the issuer.

20. The non-transitory computer readable storage media of claim 15, wherein the instructions, when executed by the at least one processor, further cause the at least one processor to transmit a notification to the merchant when the transaction to the merchant violates the fraud criteria of the selected rule.
